(19) United States
(12) Patent Application Publication
(10) Pub. No.: US 2006/0212544 A1
(43) Pub. Date: Sep. 21, 2006

(54) Method and device for transfer of image data

(76) Inventor: Uwe-Erik Martin, Protzel (DE)

Correspondence Address: SCHIFF HARDIN, LLP;PATENT DEPARTMENT, 6600 SEARS TOWER, CHICAGO, IL, 60606-6473, US

(21) Appl. No.: 11/373,424

(22) Filed: Mar. 10, 2006

(30) Foreign Application Priority Data
Mar. 10, 2005 (DE) 10 2005 011 124.6

(51) Int. Cl. G06F 15/16

(52) U.S. Cl. 709/219

(57) ABSTRACT

In a method for transfer of image data using a data transfer device wherein the image data of an image file can be separated into data packets, and transferred with variable image quality, image data of the image file are transferred in lower image quality, image data of at least one selected data packet and transferred in higher image quality, and further transfer of image data of the image file ensues in low image quality.

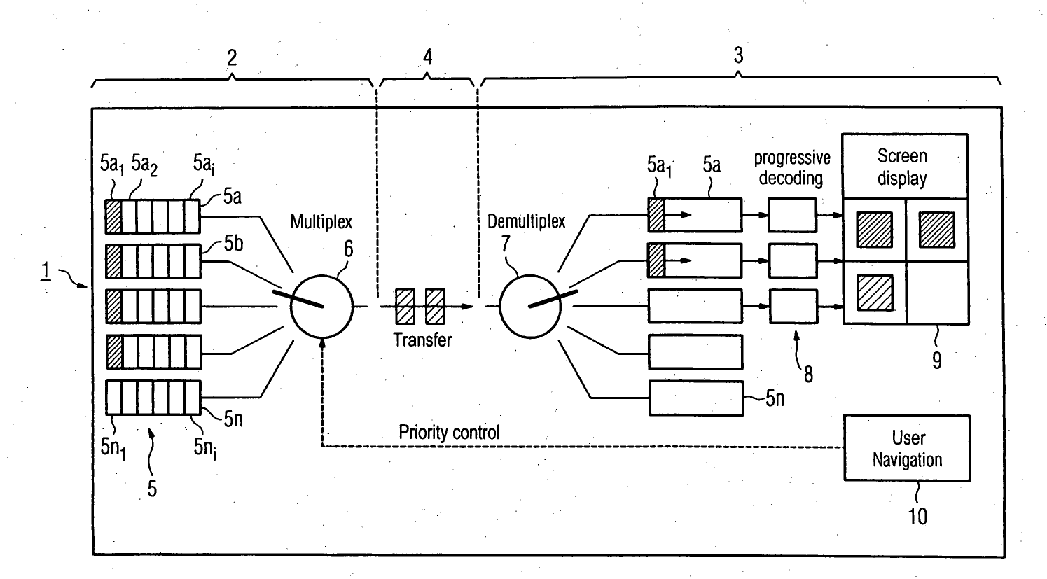

### BACKGROUND OF THE INVENTION

1. Field of the Invention

The present invention concerns a method and a device for transfer of image data, wherein the image data can be separated into a number of data packets and can be transferred in various image quality levels.

2. Description of the Prior Art

A data processing system which can transfer image data in different resolutions is known, for example, from U.S. Pat. No. 6,606,655 B1.

The method known from U.S. Pat. No. 6,606,655 in particular concerns the transfer of data over the Internet or another network with limited bandwidth. Based on the consideration that an observer sharply detects an image only where his or her eyes are focused, it is sought to specifically display the image with increased resolution at the corresponding point of the screen. For this purpose, it is necessary to track the eye movements of the observer and to evaluate them in real time. Furthermore, the image resolution would have to be increased extremely quickly at the point of the screen on which the observer concentrates in order to not irritate the eye of the observer. Overall, the method places very high requirements on both computing capacity and transfer speed.

The scalable transfer of image data is described, for example, in the article “Scalable Streaming of JPEG2000 Images using Hypertext Transfer Protocol” by Sachin Deshpande, Wenjun Zeng, Sharp Laboratories of America, Inc. The designation “JPEG2000” designates an image compression standard that allows different image quality levels, in particular different resolution levels. The term “streaming”, in the context of the Internet refers to a technology that allows data to be viewed while the data are being received (according to Lexikon Computer and Informationtechnik, 2001, Bertelsmann Lexikon Verlag GmbH; Gütersloh/München). Given the transfer of very extensive image files, for example with 14,565 pixels per line and 14,680 lines per image, the cited article proposes to initially transfer the entire image in lower image quality. If needed (indicated by markings made by the user), parts of the image can be transferred subsequently at higher image quality. Nevertheless, significant transfer times must be expected.

### SUMMARY OF THE INVENTION

An object of the present invention is to improve (relative to the prior art) the transfer of image data with adjustable image quality.

The above object is achieved in accordance with the present invention in a method and device for data transfer, wherein the image data of an image file can be separated (divided) into data packets and transferred with variable image quality, the transfer of image data of the image file ensues in lower image quality, and transfer of image data of at least one selected data packet ensues in higher image quality, and further transfer of image data of the image file ensues in low image quality.

The method assumes that the data of an image file can be separated into a number of data packets and can be transmitted with variable image quality via a data transfer device, in particular a data transfer network. The term “image data” is used herein in a broad sense and in particular encompasses encoded data as well as raw data that are provided within graphically-displayable data for further processing. The term “data transfer device” is likewise broadly used herein and encompasses all technologies for wireless as well as hardwired communications transmission.

A value that is relevant for the information quantity to be transferred per image or a combination of such values is generally referred to as “image quality”. Values that individually or in combination determine the image quality are, in particular, resolution, block size, color depth as well as transfer quota or transfer rate. “Resolution” hereby designates the number of image points (pixels or voxels) per image or length unit (for example 64 pixels per cm²). Block size designates a number of pixels that are combined into a block and with which a common color is associated, such that the one-time transmission of the color information is sufficient for representation of the entire block. Color depth designates the number of colors or grey tones that an image point or block can assume, and therewith the information quantity (for example 4 bits, 8 bits, . . . ) to be reserved per image point or per block. Given an image sequence or another moving image, “transfer quota” generally designates the transferred fraction of the total temporally sequential (or sequential in another manner), successive information. For example, given a transfer quota of 50% in relation to an image sequence, only every second image of the sequence is transferred. “Transfer rate” designates the number of the images transferred per time unit. If the image data contain additional audio information, the transfer rate can also be varied merely with regard to the audio information.

The transfer of the image data begins with low image quality, with at least parts of the transferred image data being displayed to the user at the receiver side. At any time, in particular before the entire image has been transferred in low image quality, the user has the possibility to select a part of the image and to give it a higher priority. The selection of the image section (subsequently also designated as navigation) ensues either explicitly via the user, by the user marking a part of the displayed image (for example via a frame), or is implicitly predetermined via a screen border or window border when only a part of the image is shown within the screen or window. Explicit and implicit navigation are preferably provided in parallel. For example, an image section explicitly selected by the user can be automatically enlarged to the screen size, and thus is also implicitly predetermined by the screen border. The resolution to be transferred is implicitly determined using the representation capability of the output device and an enlargement level of the image to be displayed that is set by the user.

The navigation and the prioritization that are: implemented have the result that the selected part of the image (i.e. the corresponding data packet or the corresponding data packets) is transferred with higher image quality. According to the invention, the further transfer of the non-selected image part is continued in an initially low image quality, independent of a request. In particular, the transfer of data packets to image parts that are not displayed is also continued.

The user thus has the possibility to already intervene in the mode of the transfer during the first stage of the transfer of the image data, i.e. the transfer in the lowest image quality, such that the sequence of the transfer of data packets that is provided otherwise is interrupted and a targeted transfer of at least one data packet at higher image quality is chosen. Particularly in the case of very extensive image files, the user thus can begin with the detailed processing of an image section very quickly (but still before conclusion of the transfer of the initial, lowest quality level of the image) without having to accept quality losses in this section. Through the request-independent, continued transmission of the non-selected remainder of the image, it is simultaneously ensured that a particularly large fraction of the non-selected image data is already transferred when the user re-navigates, i.e. changes the selected image section. In this manner navigation in a particularly low-delay manner with regard to the image formation is enabled from the beginning of the transmission process onwards.

The transmission principle described above is achieved particularly appropriately by the data communication between a sender (or image server) and a receiver (or image client) ensuing asynchronously with regard to the prioritization. Asynchronous communication, compared to synchronous communication, is a mode of data transmission in which at least the received process is not blocked (i.e. the process workflow is not paused) until received information exists. For the transfer method described above, this means that a transfer process running at the sender-side does not wait with the image transfer until a prioritization command initiated by the user via navigation exists, and moreover such a prioritization command only modifies the already-running transfer process, that does not begin from a waiting or stand-by state. Even when no prioritization command occurs for a longer period of time, the transmission of the data is continued with until the entire (selected and non-selected) image data are transferred at the highest image quality.

The method can be used both in the transfer of individual images and in the transfer of image sequences. In both cases, the individual images can be two-dimensional or three-dimensional images. The images preferably are transferred in a compressed form. For example, the JPEG2000 method cited above is suitable for this purpose. The decompression of the compressed data packets can ensue either as soon as these have been received or only as needed at a later point in time when the corresponding image section should be displayed. The latter cited variant has the advantage that parts of the image that are not viewed are not decompressed, and thus computer resources are conserved. By contrast, the first cited variant has the advantage that all image parts are maintained in a decompressed form and therewith can be displayed with less delay.

In an embodiment, given selection of an image section initially exclusively, the image data corresponding to the selected image section are transferred at a high image quality. The transfer of the remainder of the image is thereby continued at initially low image quality when the selected image section is completely assembled.

In contrast to this, in a preferred variant the transfer of the remainder of the image is effected with low image quality (albeit with lower priority) in parallel with the transfer of the selected image section occurring at high image quality. Given serial data transfer, the available transfer time is divided such that typically the larger fraction of the time is used for the transfer of data of the selected image section while a smaller time fraction is used for the transfer of the remainder of the image data, which are (generally) not visible on the screen. Depending on the application case, an image section is a section of a two-dimensional representation, or a partial volume of a three-dimensional image file. In the case of an image sequence to be transferred, an image section can be one or more individual images of the sequence. The non-selected part of the two-dimensional representation, the three-dimensional image file, or the image sequence is accordingly designated as the remainder of the image.

Independent of which number of dimensions are to be displayed, the transferred image packets are divided into partial data sets that define at least two (advantageously more than two, for example six) image quality levels. The simultaneous transfer of image data of different image quality levels has the particular advantage that a fast availability of the entire image (or of the entire image sequence), at least in large regions, and a high detail precision in a selected image section, are still provided during the transfer. In practice navigation can be effected without delays, particularly without stagnant image formation.

### DESCRIPTION OF THE DRAWINGS

An exemplary embodiment of the invention is shown in schematic form in the single FIGURE, as a transfer system for the transfer of image data.

### DESCRIPTION OF THE PREFERRED EMBODIMENTS

A transfer system 1 shown in the FIGURE for explanation of the inventive method and the inventive device has a first computer 2 and a second computer 3, which are coupled by a data transfer device 4. The data transfer device 4 is a network, in particular the Internet or an internal company network. The first computer 2 acts as a sender (or image server), the second computer 3 acts as a receiver (or image client).

An image file 5 is to be transferred from the first computer 2 to the second computer 3, and for this purpose is separated into n data packets 5a . . . 5n. Each of the data packets 5a . . . 5n is separated further into i respective partial data sets 5a₁ . . . 5aᵢ or, respectively, 5n₁ . . . 5nᵢ. In the exemplary embodiment, the image to be transferred is a single two-dimensional image. The segmentation of an image data set is also effected in a corresponding manner given a three-dimensional image or given sequences composed of two-dimensional or three-dimensional images.

In the exemplary embodiment, each data packet 5a . . . 5n is a typical rectangular section from the image to be transferred. The sum of the individual partial data sets 5a₁ . . . 5aᵢ, or 5n₁ . . . 5nᵢ represents the respective image section in full image quality. In the shown example, the image quality is represented by the resolution, i.e. the number of image points per data packet 5a . . . 5n.

A multiplexer 6 that enables a serial data transfer is required for transfer of the image file 5 via the data transfer device 4. A demultiplexer 7 is provided at the second computer 3. The image file 5 is progressively encoded for accelerated transfer capability (for which purpose an encoding device at the first computer 2 is used, but is not shown). The transfer of the encoded image file 5 is begun such that the first partial data set 5a₁ . . . 5n₁ from each data packet 5a . . . 5n is initially transferred. Despite the large extent of the image file 5, a complete image (if also at limited image quality) is transferred relatively quickly to the second computer 3 in this manner. Partial data sets 5a1, 5a2 etc. received by the second computer 4 are decompressed by a decoder 8 before they are displayed on a screen 9. The screen display typically does not include the entire image to be transferred, but rather only sections thereof. Nevertheless, those of the partial data sets 5a₁ . . . 5n₁ that concern image sections outside of the selected screen display are continuously transferred.

By means of an input device 10, for example a mouse or a keyboard, at any time the user has the possibility to influence the transmission of the image file 5 via the data transfer device 4 in the sense of a priority control. The priority control ensues by asynchronous data communication via the same data transfer device 4 (in particular a network) as the transfer of the image file 5 in the opposite direction. In a simple case, a prioritization of a specific image section (i.e. of a part of the image file 5) ensues implicitly by virtue of only this image section being shown to the user on the screen 9. It is also for the user to frame or, in another manner emphasize a region of the image visible on the screen, thereby selecting this region by explicit navigation (enlargement, shrinking or displacement of the displayed image section). In any case, due to such a selection of a specific image region a signal is sent to the first computer 2 that has the result that the order of the partial data sets 5a₁ . . . . 5n₁ is influenced. For example, if the user emphases that image section on the screen that is stored in the partial data sets 5a₁ . . . 5aᵢ, these partial data sets are transferred via the data transfer device 4 even if no partial data sets have yet been transferred from one or more of the data packets 5b . . . 5n. The user thus has the possibility to already specifically scale up the image quality in parts of the transferred image when not all image sections have yet been transferred.

Even when the user (in the above example) has scaled up the priority of individual data packets 5a . . . 5n, a further transfer of the remaining data packets 5a . . . 5n nevertheless ensues, but with lower priority, in particular even those data packets 5a . . . 5n that are located outside the representation selected on the screen 9. This is in contrast to the known request-response method, which merely transfers upon request those parts of an image that are located within the selected screen view. In other words: according to the inventive method, the entire image file 5 is always transferred, even when only parts of the image are visible on the screen 9. The user can set priorities within the transfer but without completely factoring out parts of the overall image. In this manner, the user can quickly navigate through the entire image without a slow-down being detectable. The method is also particularly suitable for the transfer of moving image sequences. In such a case, the image file 5 can respectively correspond to the entire image sequence and the data packets 5a . . . 5n can correspond to an individual image within the sequence.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for transferring image data using a data transfer device, wherein image data of an image file are divided into data packets and transferred with variable image quality, comprising the steps of:
transferring image data of the image file in lower image quality;
selecting a selected data packet and transferring image data of said selected data packet in higher image quality; and
transferring further image data of said image file in low image quality after said selection.

2. A method as claimed in claim 1 comprising transferring said image file via a network.

3. A method as claimed in claim 1 comprising transferring a single image as said image file.

4. A method as claimed in claim 1 comprising transferring an image sequence as said image file.

5. A method as claimed in claim 1 comprising transferring a two-dimensional image as said image file.

6. A method as claimed in claim 1 comprising transferring a three-dimensional image as said image file.

7. A method as claimed in claim 1 comprising compressing said image data before transferring said image file.

8. A method as claimed in claim 1 comprising transferring said data packets with low image quality without selection of any of said data packets transferred with low image quality.

9. A method as claimed in claim 8 comprising transferring said image data of said data packets with low image quality during transfer of said image data with higher image quality, by selection of an image section of said image file.

10. A method as claimed in claim 1 comprising dividing said image packets into partial datasets that respectively define at least two image quality levels.

11. A device for transferring image data comprising:
a first computer and a second computer connected to each other for data transfer via a data transfer device, said first and second computers being programmed to separate image data of an image file into data packets that can be transmitted with variable image quality, said device comprising:
at least one of said first and second computers being programmed to transfer said image data of said image file to the other of said first and second computers via said data transfer device with a low image quality at a beginning of transfer of said image data of said image file;
said other of said first and second computers being programmed to allow, via a user input, scaling up of image quality of at least one of the transfer data packets during transfer of said image data; and
said one of said first and second computers being programmed to continue transfer of said image data of said image file in lower image quality during or after transfer of said at least one data packet with higher image quality.

12. A device as claimed in claim 11 wherein said first computer comprises a multiplexer connected to said data transfer device.

13. A device as claimed in claim 12 wherein said second computer comprises a demultiplexer connected to said data transfer device.

14. A device as claimed in claim 14 wherein said second computer comprises an input device having a connection to said multiplexer.

15. A device as claimed in claim 11 wherein said second computer comprises a decoder.
